(19) United States
(12) Patent Application Publication
(10) Pub. No.: US 2010/0271794 A1
(43) Pub. Date: Oct. 28, 2010

(54) HARDWARE MODULE AND BACKPLANE BOARD FOR AN IED

(75) Inventors: Mathias GLOOR, Bottenwil (CH); Christian Borner, Villnachern (CH)

Correspondence Address: BUCHANAN, INGERSOLL & ROONEY PC, POST OFFICE BOX 1404, ALEXANDRIA, VA, 22313-1404, US

(73) Assignee: ABB TECHNOLOGY AG, Zurich (CH)

(21) Appl. No.: 12/765,166

(22) Filed: Apr. 22, 2010

(30) Foreign Application Priority Data
Apr. 23, 2009 (EP) 09158551.3

(51) Int. Cl. H01R 12/16

(52) U.S. Cl. 361/788

(57) ABSTRACT

The present disclosure provides a flexible and space-saving arrangement of hardware modules in an Intelligent Electronic Device (IED). A module for an IED is configured to engage a slot or socket of a backplane of the IED in order to communicate, in a point-to-point mode over a serial backplane bus system that encompasses the slot or socket, with two neighboring modules in the IED. The module includes a source selector configured to select, in a receiving mode, between reception of signals transmitted via a nearest neighbor slot, or via a next-nearest neighbor slot. The source selector evaluates signals directed towards a rear side of a circuit board of the module, with the rear side being substantially devoid of electronic components.

### RELATED APPLICATIONS

This application claims priority under 35 U.S.C. §119 to European Patent Application No. 09158551.3 filed in Europe on Apr. 23, 2009, the entire content of which is hereby incorporated by reference in its entirety.

### FIELD

The present disclosure relates to the field of device-internal communication in Intelligent Electronic Devices for Substation Automation.

### BACKGROUND INFORMATION

Substations in high and medium-voltage electric power networks include primary devices such as electrical cables, lines, bus bars, switching devices and power transformers. These primary devices are operated in an automated way via a Substation Automation (SA) system. The SA system can include secondary devices, among which Intelligent Electronic Devices (IED) are responsible for protection, control and monitoring of the primary devices. The IEDs control actuators of assigned primary devices on the base of signals from assigned sensors for switch or transformer tap changer position, temperature, voltage, current etc., signals from other IEDs, and signals from a supervisory system. Conversely, an IED communicates a state or behaviour of its assigned primary devices (e.g., selected sensor readings) to other IEDs or to the supervisory system. Depending on their intended location in the substation, and in particular on the proximity to the primary devices, the IEDs need to meet certain environment withstanding and Electromagnetic Compatibility (EMC) requirements.

In modular IEDs, a plurality of modules or cards, which each have a Printed Circuit Board (PCB) and electronic components mounted thereon, are connected via backplane connectors to an interconnecting backplane bus. The latter may operate, for example, according to a point-to-point bus topology, which involves a dedicated driver and receiver pair per channel. A limited number of transitions from one medium to the next (i.e. a transition from a printed circuit board to a cable via a connector) imply that the channel will most likely have well-controlled impedance, which in turn allows very high signaling rates. In particular, Low Voltage Differential Signaling (LVDS), Current Mode Logic (CML), and Low Voltage Positive Emitter Coupled Logic (LVPECL) are differential signaling technologies designed for point-to-point signal transmission, with driver-output signals comprising fast edges that allow multi-gigabit transmission. For instance, a 350 mV signal swing of LVDS enables data rates of up to 3 Gbps while consuming only a small amount of power.

Accordingly, LVDS is considered a very efficient technology, despite of the fact that the fast signal edges are very sensitive to any impedance discontinuities and demand careful interconnect designs. The so-called interconnect, or physical signal path, can include two printed conductor traces on a backplane board. Controlled impedance of interconnect, proper driver load, and interconnect termination are factors for consideration when designing for low-jitter signal transmission. An economic advantage resides in the fact that a single cost-cutting Field-Programmable Gate Array (FPGA)-internal LVDS driver may provide sufficient signal quality and sufficient transmission power for point-to-point communication. On the other hand, multipoint topologies, and in particular “multi-drop” topologies with a single driver and multiple receivers per channel, require additional amplification of the transmitted signal.

The backplane board, in addition to hosting the backplane bus, can be configured to distribute additional signals, such as clock signals, for example, and to provide power supply voltage to the modules. In some IEDs, the width of the modules (e.g., their maximum extension in a direction perpendicular to the PCB as essentially defined by tallest components mounted thereon) may not be uniform. The non-uniformity of width may occur, for example, in I/O modules, which include a plurality of clamps for hard-wiring copper cables to various Instrument Transformers or other analog/binary signal sources, or which include bulky components such as current/voltage transformers mounted on the PCB. If the number of such oversized modules and their relative arrangement to the other, standard-sized modules is not to be predefined upfront, the backplane board may be equipped with uniformly spaced slots for accommodating the modules, with a uniform lateral spacing according to the maximum module width. This, however, amounts to an unwanted waste of space. As a cost-wise alternative with a backplane bus somewhat detached from the backplane board, a flat ribbon cabling may be used for flexible and space-saving point to point connection between the modules.

### SUMMARY

An exemplary embodiment provides a hardware module for an Intelligent Electronic Device (IED) having a backplane. The exemplary hardware module comprises a circuit board, and electronic components mounted on the circuit board. In addition, the exemplary hardware module comprises a backplane connector configured to engage a slot of a backplane of the IED, to enable the module to receive, over a serial backplane bus of the backplane, and process a signal from a source module of the IED. The exemplary hardware module also comprises a source selector configured to determine whether a first neighboring module engages a nearest slot of the backplane and to utilize the first neighboring module as the source module if the first neighboring module is determined to engage the nearest slot of the backplane, and to, a utilize a second neighboring module engaging a next-nearest slot of the backplane as the source module if the first neighboring module is determined to not engage the nearest slot of the backplane.

### BRIEF DESCRIPTION OF THE DRAWINGS

Additional refinements, advantages and features of the present disclosure are described in more detail below with reference to exemplary embodiments illustrated in the drawings, in which:

FIG. 1 schematically depicts a cross-sectional view of an exemplary IED with five modules;

FIG. 2 depicts a top view of a backplane with five slots according to an exemplary embodiment;

FIG. 3 is a table summarizing the signal flow between four neighboring slots according to an exemplary embodiment; and

FIG. 4 shows some inter-module routing paths, unused lines and unused stub lines according to an exemplary embodiment.

The reference symbols used in the drawings, and their meanings, are listed in summary form in the list of reference symbols below. In principle, identical components and/or identically functioning components are provided with the same reference symbols in the drawings.

### DETAILED DESCRIPTION

Exemplary embodiments of the present disclosure provide a flexible and space-saving arrangement of modules in an Intelligent Electronic Device (IED). According to an exemplary embodiment, the flexible and space-saving arrangement of modules in an IED may be achieved by a hardware module and a backplane board.

According to an exemplary embodiment of the present disclosure, a hardware module for an IED is configured to engage a slot or socket of a backplane of the IED in order to communicate, in a point-to-point mode over a serial backplane bus system that encompasses the slot or socket, with two neighboring modules in the IED. The module includes a source selector to select, in a receiving mode, between reception of signals transmitted via a nearest neighbor slot, or via a next-nearest neighbor slot. According to an exemplary embodiment, the nearest neighbor slot can be designated as a preferred slot from which to receive signals at the module. In this context, “near” and “nearest neighbor” refer to the spatial (e.g., linear) arrangement of the slots on the backplane of the IED with respect to the slot engaged by the hardware module itself. It is further understood that the next-nearest neighbor slot in turn is a nearest neighbor slot to the original nearest neighbor slot. The source selector evaluates signals directed towards a rear side of a circuit board of the module, with the rear side being substantially devoid of electronic components. This communication direction is designated as a “down” direction herein.

In accordance with an exemplary embodiment, the module itself is configured to transmit a signal in the “down” direction in parallel to both a nearest slot and a next-nearest neighbor slot.

In accordance with another exemplary embodiment of the present disclosure, the module is permanently configured to receive exclusively, in an “up” direction opposite to the “down” direction, signals from a neighboring module engaging a nearest slot if the module has a standard width, or from a neighboring module engaging a next-nearest slot if the width of the module exceeds a standard width.

According to an exemplary embodiment, Field-Programmable Gate Array (FPGA) internal LVDS drivers are powerful enough for a backplane bus using Low Voltage Differential Signaling (LVDS) in a full duplex topology.

In an exemplary embodiment of the present disclosure, a backplane board can include a number of evenly distributed slots for accommodating modules. A lateral distance between the slots can correlate with the standard module width, and the engaging modules can, for example, form an arrangement of extension boards geometrically oriented in parallel. Two signal paths or channels, printed on otherwise supported by the backplane board, terminate at each slot and connect the latter to a source at a nearest and a next-nearest slot.

Each of the two signal paths may be a completely individual or isolated path interconnecting two slots. Alternatively, both signal paths may include a bifurcation or junction, from which another signal path branches off. The two branches having a common origin at a particular source slot terminate at a nearest and next-nearest neighbor slot of the source slot, respectively. This topology involves a single signal driver per source module and communication direction, and is advantageously employed in an “up” direction, where termination resistance and receiver are connected to only one of the two branches.

An IED including a backplane and hardware module as described above is particularly advantageous for a use in Substation Automation, as it minimizes space requirements and presents a backplane bus connection topology that gives rise to only a limited number of relatively short unused stub lines, and thus results in high signal integrity and very good Electromagnetic Compatibility (EMC) and Electrostatic Discharge (ESD) strength.

Modern IEDs in Substation Automation often use a serial high-speed signaling with point-to-point topology in order to exchange data packets between a base or master module and extension modules comprising multiple functionality for protection, control and monitoring purposes in electric power systems. All connections regarding data exchange between modules are done via a passive backplane Printed Circuit Board (PCB). Data packets are forwarded from module to module until the destination module is reached. In order to accommodate modules with a width exceeding the distance between two physical slots of the backplane board some kind of selecting or switching mechanism is needed to ensure communication either to the next slot or to the next-but-one slot.

FIG. 1 schematically depicts a cross-sectional view of internal components of an exemplary IED along the intersection of a backplane board 1 and the modules 20 to 24 arranged on the backplane board 1. Each of the modules includes a PCB 24a and a backplane connector 24b for electrically connecting the corresponding module to the backplane board 1. To the left of each PCB (e.g., PCB 24a) in the exemplary arrangement illustrated in FIG. 1, a space 24c for accommodating the electronic components is indicated with broken lines. In the exemplary embodiment illustrated in FIG. 1, module 24 is shown to have a PCB 24a, a backplane connector 24b, and a space 24c for accommodating electronic components. It is to be understood that each other module 20-23 are similarly equipped with a corresponding PCB, backplane connector and space for accommodating electronic components, respectively.

In the exemplary embodiment illustrated in FIG. 1, the central module 22 has a width that is somewhere the standard width and double the standard width of the other modules 20, 21, 23, 24. Equally spaced slots 1a to 1f are arranged on the backplane board 1. According to an exemplary embodiment, the distance between two neighboring slots corresponds to the standard module width.

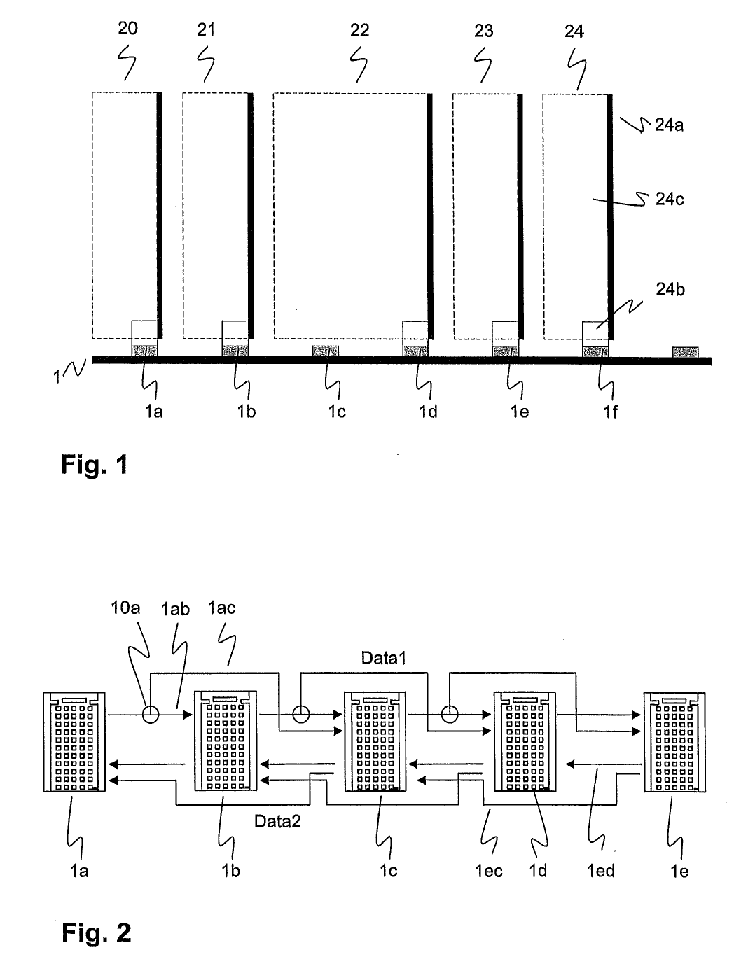

FIG. 2 schematically depicts a top view of the backplane board 1 with five slots 1a to 1e, which are each in the form of a rectangular array having, for example, fifty-five individual pin connectors (e.g., male or female type connectors) to engage with corresponding counterpart connectors of a backplane connector (e.g., backplane connector 24b illustrated in FIG. 1). The electrical connections between the slots are depicted as solid lines, wherein each connection or line corresponds to two conductor traces (positive and negative) printed on the backplane board and terminating at a pair of two of the above-described pin connectors. A Data1 signal is propagated from the left-most slot 1a, which may accommodate a basic or master module, in an “up” direction to the other slots 1b to 1e that in turn accommodate extension modules. All “up” connections between neighboring modules comprise a bifurcation or “Y”-junction 10a, from which the Data1 signal is further transmitted in parallel over two branch lines 1ab, 1ac to both the nearest 1b and the next nearest 1c slot. Hence, any “up” signal as sent by a source module via a single pair of pins is destined to two neighboring slots. On the other hand, Data2 signals that are propagated in a “down” direction from right to left can do so via two entirely distinct paths 1ed, 1ec, which originate at respectively distinct pairs of pin connectors at the source slot 1e and terminate at the nearest 1d and next nearest 1c neighbor slot, respectively.

FIG. 3 is a table summarizing the above-described signal flow between four neighboring slots. The “up” signal Data1 is generated as dout1 in slot n (e.g., slot 1a in FIG. 2) and received as din1a at the near neighbor (slot n+1, e.g., slot 1b in FIG. 2) and as din1b at the far neighbor (slot n+2). The “down” signals Data2 are prepared as dout2a and dout2b (e.g., in slot le in FIG. 2), and received as din2a and din2b at the near and far neighbors, respectively.

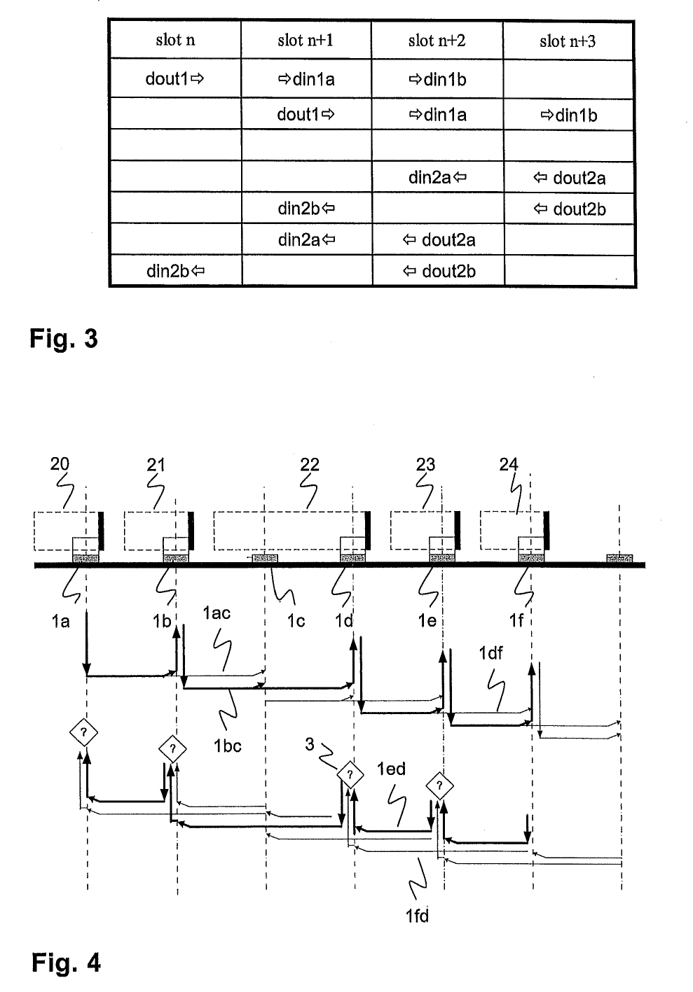

In FIG. 4, the modules of FIG. 1 are depicted in part, together with intra-module routing paths as indicated by vertical arrows underneath each module, as well as inter-module routing paths as indicated by horizontal arrows. Inter-module communication includes, in an “up” direction from left to right (according to the exemplary arrangement of modules in FIGS. 1 and 4), sending, by the first and left-most module 20, a message to the second module 21 (bold arrow). By virtue of the above-mentioned bifurcation 10a at or near slot 1b, the same signal is also sent to unused slot 1c along an unused branch or stub line 1ac. The second module 21 in turn sends signals along a dedicated trace on the backplane board to slot 1c, and further to slot 1d which accommodates oversized module 22. Module 22 further transmits the “up” signals to neighboring modules 23 and 24. However, with module 24 being aware of its standard width and hence of the fact that a close neighboring module 23 exists, the signal from module 22 is ignored by module 24, which in turn makes branch 1df an unused stub line. This can be achieved, for example, by omitting or interrupting, on the PCB of module 24, the conductor trace leading to the counterpart connectors of branch 1df. Signal quality considerations of the “up” Data1 in the above embodiments does not require a termination resistance for the unused branches, neither on the backplane board nor on the module itself.

In the bottom half of FIG. 4, every transmitting module sends the Data2 signals in the opposite or “down” direction (e.g., from right to left) on distinct paths to both the nearest and the next-nearest neighbor. Since exemplary receiving module 22 has a termination resistor of 100 Ω for both the path 1ed from the nearest neighbor module 23 and the path 1fd from the next-nearest neighbor module 24, the receiving module 22 can determine if the differential voltage is close to 0 Volts, or if there is a LV driver at the other end of each signal path. The receiving module may thus determine whether or not the signal from the nearest neighbor (data2a) and/or the signal from the next nearest neighbor (data2b) exists. According to an exemplary embodiment, in the event signals are received from both the near neighbor and the next-nearest neighbor, the receiving module can be configured to determine that the signal received from the near neighbor 23 is chosen for further processing (instead of the signal received from the next-nearest neighbor 24), making the entire path 1fd from the far neighbor 24 an unused line with proper termination. On the other hand, if during a specific amount of time of, for example, 100 ns following power-up or after a reset no signal from the near located module is detected, a source selector 3 at the receiver automatically chooses the signal from the far located module. During normal operation and until the next power-up or reset process is initiated, the above choice generally remains unchallenged.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 backplane board
1a-1f slot
1ab, 1ac, 1df “up” branch
1ed, 1ec, fd “down” path
10a bifurcation
20-24 module

### 24a PCB

24b backplane connector
24c space for electronic components
3 source selector

What is claimed is:

1. A hardware module for an Intelligent Electronic Device (IED) having a backplane, the hardware module comprising:
a circuit board;
electronic components mounted on the circuit board;
a backplane connector configured to engage a slot of a backplane of the IED, to enable the module to receive, over a serial backplane bus of the backplane, and process a signal from a source module of the IED; and
a source selector configured to determine whether a first neighboring module engages a nearest slot of the backplane and to utilize the first neighboring module as the source module if the first neighboring module is determined to engage the nearest slot of the backplane, and to, a utilize a second neighboring module engaging a next-nearest slot of the backplane as the source module if the first neighboring module is determined to not engage the nearest slot of the backplane.

2. The module according to claim 1, wherein the module is configured to transmit, as a source module, a signal to a nearest slot and to a next-nearest slot.

3. The module according to claim 1, wherein the module is configured to receive, according to a width of the module, signals from one of a nearest slot of the backplane and a next-nearest slot of the backplane.

4. The module according to claim 1, comprising a Field-Programmable Gate Array (FPGA) having an embedded driver for Low Voltage Differential Signaling (LVDS).

5. A backplane board for an IED, the backplane board comprising:
a serial backplane bus; and
regularly spaced slots configured to accommodate and communicatively interconnect, via the serial backplane bus, a number of hardware modules according to claim 1,
wherein the backplane board comprises two signal paths leading to a slot and originating at a nearest and a next-nearest slot.

6. The backplane board according to claim 5, wherein the signal path from the next-nearest slot comprises a bifurcation, from which another signal path leads to the nearest slot.

7. The backplane board according to claim 5, wherein the hardware modules and IED are configured to perform Substation Automation.

8. A backplane board for an IED, the backplane board comprising:
a serial backplane bus; and
regularly spaced slots configured to accommodate and communicatively interconnect, via the serial backplane bus, a number of hardware modules according to claim 2,
wherein the backplane board comprises two signal paths leading to a slot and originating at a nearest and a next-nearest slot.

9. The backplane board according to claim 8, wherein the signal path from the next-nearest slot comprises a bifurcation, from which another signal path leads to the nearest slot.

10. The backplane board according to claim 6, wherein the hardware modules and IED are configured to perform Substation Automation.

11. A backplane board for an IED, the backplane board comprising:
a serial backplane bus; and
regularly spaced slots configured to accommodate and communicatively interconnect, via the serial backplane bus, a number of hardware modules according to claim 3,
wherein the backplane board comprises two signal paths leading to a slot and originating at a nearest and a next-nearest slot.

12. The backplane board according to claim 11, wherein the signal path from the next-nearest slot comprises a bifurcation, from which another signal path leads to the nearest slot.

13. The backplane board according to claim 11, wherein the hardware modules and IED are configured to perform Substation Automation.

14. A backplane board for an IED, the backplane board comprising:
a serial backplane bus; and
regularly spaced slots configured to accommodate and communicatively interconnect, via the serial backplane bus, a number of hardware modules according to claim 4,
wherein the backplane board comprises two signal paths leading to a slot and originating at a nearest and a next-nearest slot.

15. The backplane board according to claim 14, wherein the signal path from the next-nearest slot comprises a bifurcation, from which another signal path leads to the nearest slot.

16. The backplane board according to claim 14, wherein the hardware modules and IED are configured to perform Substation Automation.
